(19) United States
(12) Patent Application Publication
(10) Pub. No.: US 2017/0201340 A1
(43) Pub. Date: Jul. 13, 2017

(54) METHOD FOR RECEIVING BROADCAST CHANNEL AND APPARATUS THEREFOR

(71) Applicant: LG ELECTRONICS INC., Seoul (KR)

(72) Inventors: Kunil YUM, Seoul (KR); Yunjung YI, Seoul (KR); Kijun KIM, Seoul (KR); Hyunsoo KO, Seoul (KR)

(73) Assignee: LG ELECTRONICS INC., Seoul (KR)

(21) Appl. No.: 15/400,785

(22) Filed: Jan. 6, 2017

Related U.S. Application Data
(60) Provisional application No. 62/276,231, filed on Jan. 8, 2016.

(51) Int. Cl. H04J 13/00; H04W 72/04; H04W 72/00; H04W 4/06

(52) U.S. Cl. CPC H04J 13/0048; H04W 4/06; H04W 72/0446; H04W 72/005

(57) ABSTRACT

Provided is a method for receiving a broadcast channel repeatedly transmitted in a plurality of subframes in a wireless communication system, the method being performed by a terminal and including detecting information on Walsh cover code to be applied to the broadcast channel; multiplying symbols of resource elements (REs) for the broadcast channel, received in each of the plurality of subframes, by an element of the detected Walsh cover code for a respective subframe; adding symbols of RE multiplied by a corresponding element of the detected Walsh cover code at the same position in each of the plurality of subframes to each other; and decoding symbols except for symbols of REs of a legacy reference signal determined based on power of the added symbols.

### CROSS-REFERENCE TO RELATED APPLICATIONS

Pursuant to 35 U.S.C. §119(e), this application claims the benefit of U.S. Provisional Patent Application No. 62/276,231, filed on Jan. 8, 2016, the contents of which are hereby incorporated by reference herein in its entirety.

### BACKGROUND OF THE INVENTION

Field of the Invention

The present invention relates to a wireless communication system and, more particularly, to a method for receiving a broadcast channel and an apparatus therefor.

Discussion of the Related Art

NB-IoT (narrow band-Internet of things) performs transmission using a narrow band, for example, only one RB, differently from legacy LTE, particularly, MTC (machine type communication). Such a transmission method is applied to all DL and UL channels and thus a payload size is reduced even in channels for system information transmission, such as PBCH (physical broadcast channel). Accordingly, a method of transmitting each channel over a larger number of subframes is considered. For example, a PBCH is transmitted per radio frame (10 ms) N times (e.g., 64 times) using the entire 0-th subframe instead of being transmitted per 10 ms through 4 symbols of the second slot in legacy LTE. This refers to a method of transmitting the PBCH in K (e.g., 8) PBCH transmission instances and transmitting corresponding PBCH blocks (i.e., K PBCH transmission instances) repeatedly (N/K times).

### SUMMARY OF THE INVENTION

Accordingly, the present invention is directed to a method for receiving a broadcast channel by an NB-IoT UE and an apparatus therefor.

The technical problems solved by the present invention are not limited to the above technical problems and those skilled in the art may understand other technical problems from the following description.

According to an aspect of the present invention, there is provided a method for receiving, a broadcast channel repeatedly transmitted in a plurality of subframes in a wireless communication system, including: detecting, by a terminal, information on Walsh cover code to be applied to the broadcast channel; multiplying, by the terminal, symbols of resource elements (REs) for the broadcast channel, received in each of the plurality of subframes, by an element of the detected Walsh cover code for a respective subframe; adding, by the terminal, symbols of RE multiplied by a corresponding element of the detected Walsh cover code at the same position in each of the plurality of subframes to each other; and decoding, by the terminal, symbols except for symbols of REs of a legacy reference signal determined based on power of the added symbols.

Additionally or alternatively, the length of the Walsh cover code may be an even number equal to or greater than 2.

Additionally or alternatively, the Walsh cover code may include the same number of +1s and −1s as elements.

Additionally or alternatively, the information on the Walsh cover code may be detected through blind detection of a synchronization signal.

Additionally or alternatively, the broadcast channel may be received through a plurality of radio frames within a predetermined period.

Additionally or alternatively, the same Walsh cover code may be applied to subframes within the plurality of radio frames.

Additionally or alternatively, the broadcast channel may be received in each of a plurality of radio frames within a predetermined period.

Additionally or alternatively, the same Walsh cover code may be applied to subframes having the same index in the plurality of radio frames.

Additionally or alternatively, the number of subframes may be equal to the length of the Walsh cover code.

According to another aspect of the present invention, there is provided a terminal configured to receive a broadcast channel repeatedly transmitted in a plurality of subframes in a wireless communication system, the UE including: a transmitter and a receiver; a processor configured to control the transmitter and the receiver, wherein the processor is configured to detect information on Walsh cover codes to be applied to the broadcast channel, to multiply symbols of resource elements (REs) for the broadcast channel, received in each of the plurality of subframes by an element of the detected Walsh cover code for a respective subframe, to add symbols of RE multiplied by a corresponding element of the detected Walsh cover code at the same position in each of the plurality of subframes to each other, and to decode symbols except for symbols of REs of a legacy reference signal determined based on power of the added symbols.

Additionally or alternatively, the length of the Walsh cover code may be an even number equal to or greater than 2.

Additionally or alternatively, the Walsh cover code may include the same number of +1s and −1s as elements.

Additionally or alternatively, the information on the Walsh cover code may be detected through blind detection of a synchronization signal.

Additionally or alternatively, the broadcast channel may be received through a plurality of radio frames within a predetermined period.

Additionally or alternatively, the same Walsh cover code may be applied to subframes within the plurality of radio frames.

Additionally or alternatively, the broadcast channel may be received in each of a plurality of radio frames within a predetermined period.

Additionally or alternatively, the same Walsh cover code may be applied to subframes having the same index in the plurality of radio frames.

Additionally or alternatively, the number of subframes may be equal to the length of the Walsh cover code.

The aforementioned technical solutions are merely parts of embodiments of the present invention and various embodiments in which the technical features of the present invention are reflected can be derived and understood by a person skilled in the art on the basis of the following detailed description of the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an exemplary radio frame structure used in a wireless communication system;

FIG. 2 illustrates an exemplary downlink/uplink (DL/UL) slot structure in a wireless communication system;

FIG. 3 illustrates a downlink (DL) subframe structure used in a 3GPP LTE/LTE-A system;

FIG. 4 illustrates an exemplary uplink (UL) subframe structure used in a 3GPP LTE/LTE-A system;

FIG. 5 illustrates an example of mapping REs to a subframe to which a Walsh cover code has been applied according to an embodiment of the present invention;

FIG. 6 illustrates an example of mapping REs to a subframe to which a Walsh cover code has been applied according to an embodiment of the present invention;

FIG. 7 illustrates an example of repeated transmission of a broadcast channel in a plurality of subframes;

FIG. 8 illustrates an example of repeated transmission of a broadcast channel to which a Walsh cover code has been applied in a plurality of subframes according to an embodiment of the present invention;

FIG. 9 illustrates an example of repeated transmission of a broadcast channel to which a Walsh cover code has been applied in a plurality of subframes according to an embodiment of the present invention;

FIG. 10 illustrates an example of repeated transmission of a broadcast channel to which a Walsh cover code has been applied in a plurality of subframes according to an embodiment of the present invention;

FIG. 11 illustrates an example of repeated transmission of a broadcast channel to which a Walsh cover code has been applied in a plurality of subframes according to an embodiment of the present invention;

FIG. 12 illustrates an example of port rotation transmission according to an embodiment of the present invention;

FIG. 13 illustrates an additional RS pattern according to an embodiment of the present invention;

FIG. 14 illustrates an example of repetition of a port rotation operation according to an embodiment of the present invention;

FIG. 15 illustrates an operation according to an embodiment of the present invention; and

FIG. 16 is a block diagram of apparatuses for implementing embodiments of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

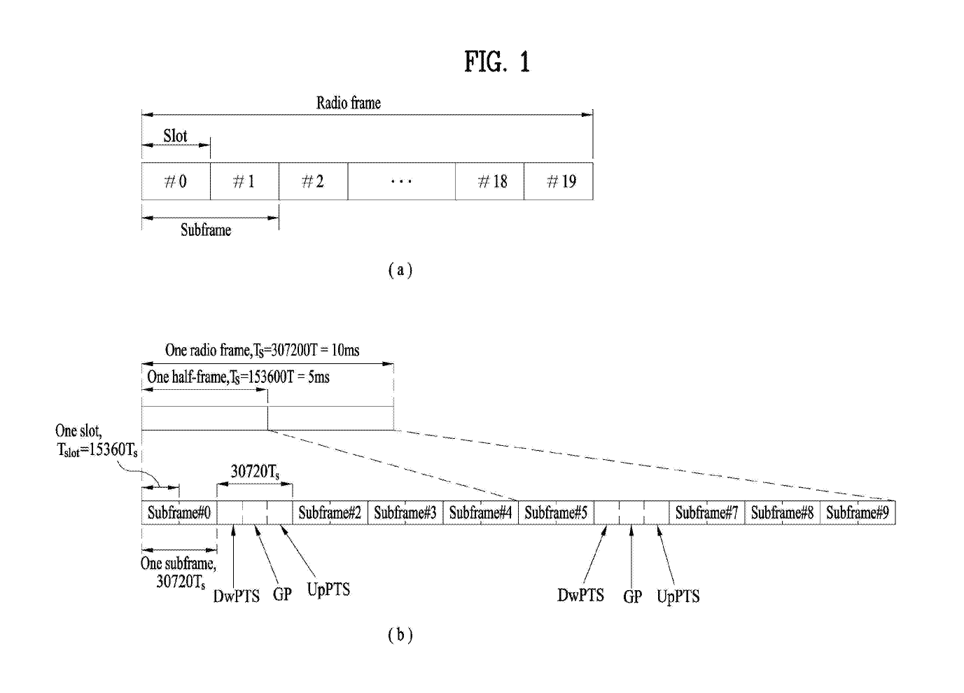

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| DL-UL | to-Uplink | | | | | | | | | | |
| con- | Switch-point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

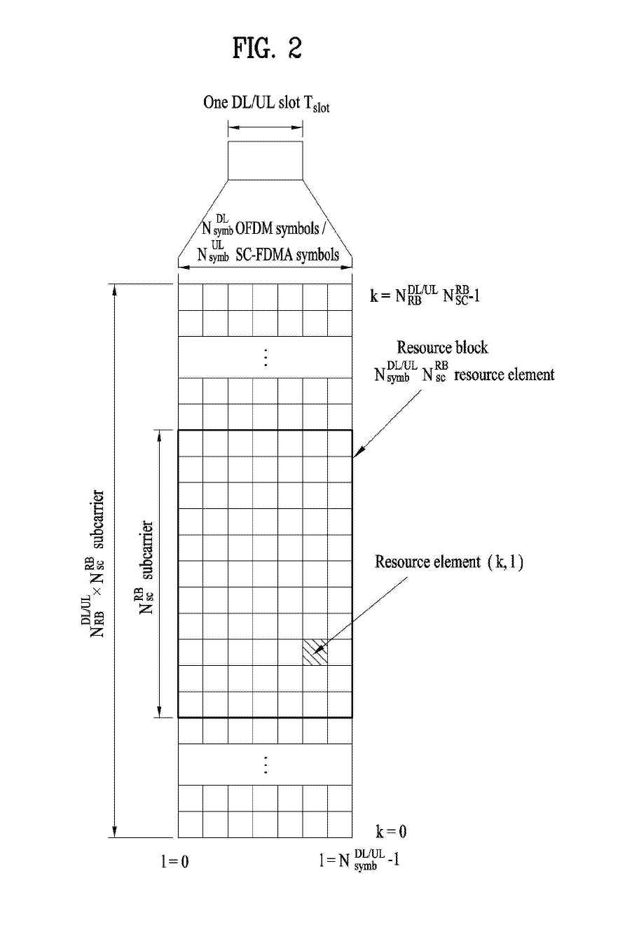

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, 1) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

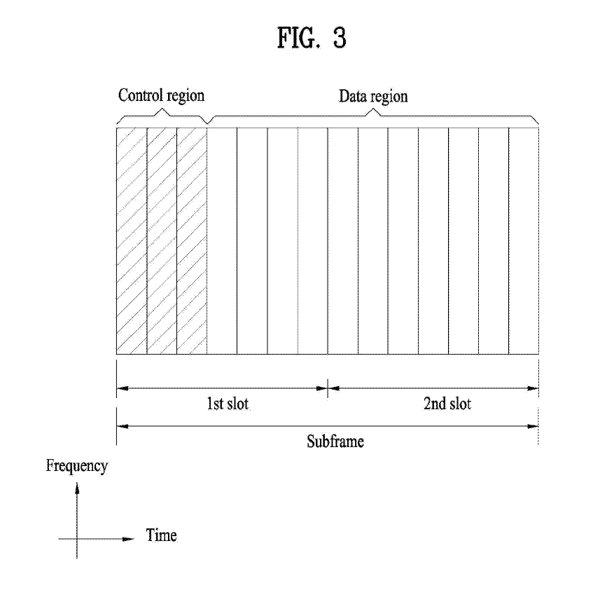

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | | Size | Number of PDCCH |
| Type | Aggregation Level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number | | |
|---|---|---|---|---|
| | | of bits | | |
| | | per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + BPSK | 21 | CQI/PMI/RI + | Normal CP |
| | | | ACK/NACK | only |
| 2b | QPSK + QPSK | 22 | CQI/PMI/RI + | Normal CP |
| | | | ACK/NACK | only |
| 3 | QPSK | 48 | ACK/NACK or | |
| | | | SR + ACK/NACK | |
| | | | or CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

PBCH (Physical Broadband Channel)

In LTE/LTE-A, a PBCH is used for MIB (master information block) transmission. A description will be given of a method of configuring the PBCH.

Bit blocks b(0), . . . ,b(M_{bit}−1) are scrambled with a cell-specific sequence before modulation to be produced as scrambled bit blocks \tilde{b}(0), . . . ,\tilde{b}(M_{bit}−1). Here, M_{bit} represents the number of bits transmitted over a PBCH, and 1,920 bits are used for a normal cyclic prefix and 1,728 bits are used for an extended cyclic prefix.

Equation 1 represents a method of scrambling bit blocks.

\tilde{b}(i)=(b(i)+c(i))mod 2 [Equation 1]

In Equation 1, c(i) denotes a scrambling sequence. The scrambling sequence is initialized to cᵢₙᵢₜ=N_{ID}^{cell} in each radio frame that satisfies n_{f} mod 4=0.

The scrambled bit blocks \tilde{b}(0), . . . ,\tilde{b}(M_{bit}−1) are modulated to produce complex-value modulated symbol blocks d(0), . . . ,d(M_{symb}−1). Here, QPSK (Quadrature Phase Shift Keying) can be applied to the PBCH as a modulation scheme.

The modulated symbol blocks d(0), . . . ,d(M_{symb}−1) are mapped to one or more layers. Here, M_{symb}⁽⁰⁾=M_{symb}. Then, the modulated symbol blocks are precoded to produce vector blocks y(i)=[y⁽⁰⁾(i) . . . y^{(P-1)}(i)]^{T}. Here, i=0, . . . ,M_{symb}−1. In addition, y^{(p)}(i) denotes a signal for an antenna port p, p=0, . . . ,P−1 and P∈{1,2,4}. Here, p represents the number of an antenna port for a cell-specific reference signal.

Complex-value symbol blocks y^{(p)}(0), . . . ,^{(p)}(M_{symb}−1) for each antenna port are transmitted in 4 consecutive radio frames from a radio frame that satisfies n_{f} mod4=0. The complex-value symbol blocks are mapped to resource elements (k, 1) other than resource elements reserved for transmission of reference signals in ascending order from index k, mapped to index 1 of slot #1 of subframe #0 and then mapped to a radio frame number. Resource element indices are provided as represented by Equation 2.

$$k = \frac{{N}_{RB}^{DL} {N}_{sc}^{RB}}{2} - 36 + {k}^{′} , {k}^{′} = 0 , 1 , … , 71 \\ l = 0 , 1 , … , 3 \qquad [ Equation 2 ]$$

Resource elements for reference signals are excluded from mapping. Mapping is performed on the assumption that cell-specific reference signals for antenna ports #0 to #3 are present irrespective of actual configuration. A UE assumes that resource elements, which are presumed to be reserved for reference signals but are not used for reference signal transmission, are not available for PDSCH transmission. The UE does not perform supposition for such resource elements.

MIB (Master Information Block)

An MIB is system information transmitted over a PBCH. That is, the MIB includes system information transmitted through a BCH. With respect to the MIB, a signaling radio bearer is not applied, an RLC-SAP (Radio Link Control-Service Access Point) is a TM (Transparent Mode), and a logical channel is a BCCH (Broadcast Control Channel). The MIB is transmitted to a UE in E-UTRAN. The following table shows an exemplary MIB format.

TABLE 5
-- ASN1START
MasterInformationBlock ::= SEQUENCE {

| | |
|---|---|
| dl-Bandwidth | ENUMERATED { |
| | n6, n15, n25, n50, n75, n100}, |
| phich-Config | PHICH-Config, |
| systemFrameNumber | BIT STRING (SIZE (8)), |
| spare | BIT STRING (SIZE (10)) |
| } | |
| -- ASN1STOP | |

The MIB includes a downlink bandwidth parameter, a PHICH configuration parameter, a system frame number parameter and reserved bits.

The downlink bandwidth parameter represents 16 different transport bandwidth configurations NRB. For example, n6 corresponds to 6 resource blocks and n15 corresponds to 15 resource blocks. The PHICH configuration parameter indicates a PHICH configuration necessary to receive a control signal on a PDCCH necessary to receive a DL-SCH. The system frame number (SFN) parameter defines 8 most significant bits (MSBs) of the SFN. Here, 2 least significant bits (LSBs) of the SFN are indirectly acquired through PBCH decoding. For example, 40 ms timing of a PBCH TTI can indicate 2 LSBs.

A description will be given of a method of transmitting and receiving a PBCH for an NB-IoT UE.

NB-IoT (narrow band-Internet of things) performs transmission using a narrow band, for example, only one RB, differently from legacy LTE, particularly, MTC (machine type communication). Such a transmission method is applied to all DL and UL channels and thus a payload size is reduced even in channels for system information transmission, such as PBCH (physical broadcast channel). Accordingly, a method of transmitting each channel over a larger number of subframes is considered. For example, a PBCH is transmitted per radio frame (10 ms) N times (e.g., 64 times) using the entire 0-th subframe instead of being transmitted over central 72 subcarriers in 4 symbols of the second slot of the first subframe in 4 consecutive radio frames of legacy LTE. This refers to a method of transmitting the PBCH in K (e.g., 8) PBCH transmission instances and transmitting corresponding PBCH blocks (i.e., K PBCH transmission instances) repeatedly (N/K times).

For NB-IoT transmission, an in-band method using an LTE band, a guard band method using an LTE guard band and a stand-alone method using a band independent of the LTE band are considered. In the case of the in-band method, transmission of legacy CRSs for legacy LTE UEs may become a problem. An NB-IoT UE cannot be aware of the number of legacy CRS ports because it cannot read system information of legacy LTE and cannot recognize a v-shift value of a legacy CRS pattern if a legacy cell ID is not signaled through a synchronization channel or an NB-IoT cell ID differs from the legacy cell ID.

Accordingly, the UE receives the number and positions of CRS ports of a legacy LTE base station through a synchronization signal for PBCH transmission or transmits a PBCH by rate-matching legacy CRS REs on the assumption of a maximum number of CRS ports. In this case, however, the number of times of synchronization signal blind detection (BS) may increase so as to increase UE complexity or a PBCH payload size of the NB-IoT UE is reduced by additional RSs for legacy CRS+NB-IoT. Particularly, when a cell ID is not received through a synchronization signal, the PBCH payload size may be remarkably reduced.

To avoid this, the present invention proposes a method of applying a Walsh cover code to a PBCH for an NB-IoT UE and transmitting the PBCH in a period in which the PBCH is repeatedly transmitted. The Walsh cover code needs to include the same number of +1s and −1s as elements thereof Then, a base station can repeatedly transmit the PBCH or part thereof for coverage enhancement and a UE can cancel out a CRS included in a payload when multiplying PBCHs phase-compensated through RSs by the Walsh cover code, adding the PBCHs and decoding the PBCHs. While a Walsh cover code {1, −1} with a length of L=2 is used in the specification for convenience, L may be an even number exceeding 2. The UE receives subframes corresponding to a multiple of a natural number of L (e.g., 2, 4, 6, . . . when L=2) and then attempts decoding by applying the Walsh cover code to the subframes.

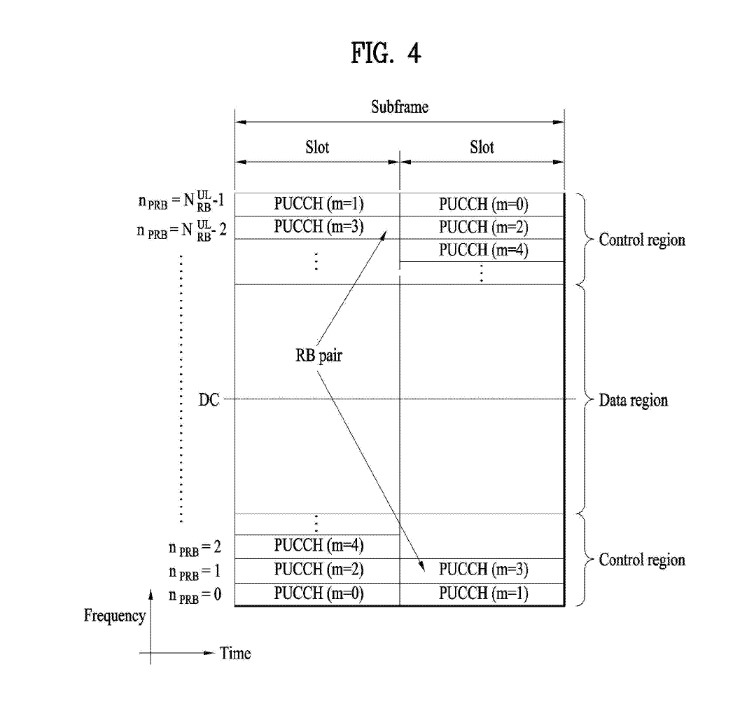

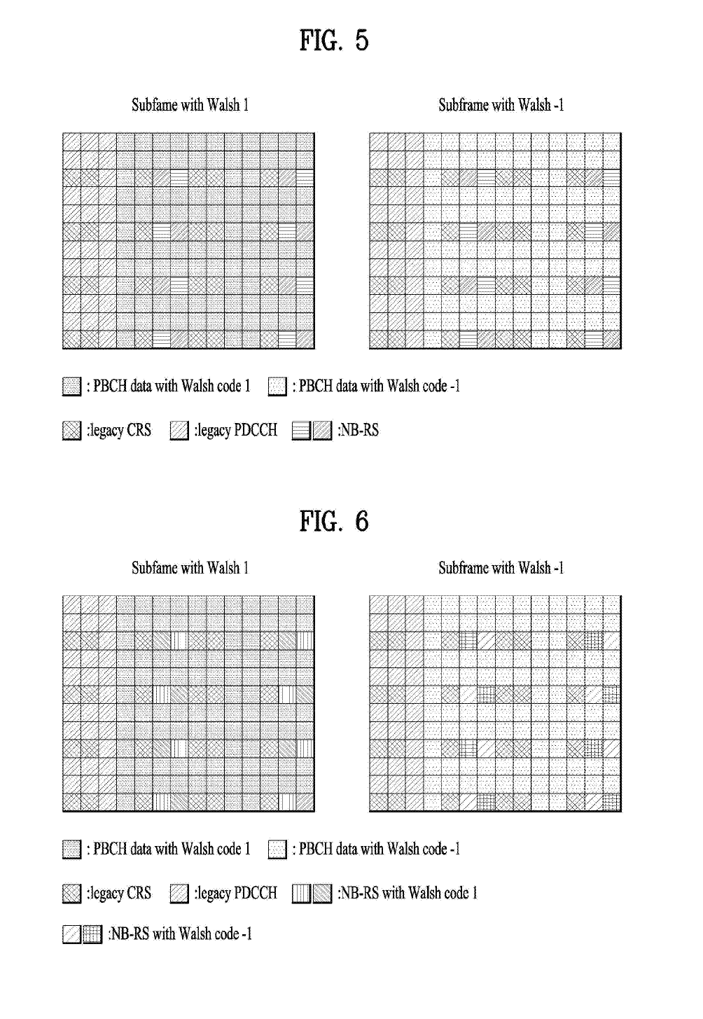

FIG. 5 illustrates a PBCH to which a Walsh cover code has been applied according to an embodiment of the present invention.

An NB-RS is a reference signal that can be added and used for NB-IoT. As shown in FIG. 5, different Walsh cover codes are applied to REs through which PBCH data is transmitted. Accordingly, when a UE multiplies a subframe to which an element ‘−1’ of the Walsh cover code has been applied by a base station by −1 and combines the subframe with a subframe to which an element ‘+1’ of the Walsh cover code has been applied during decoding, the PBCH data can be boosted to reduce noise variance and the remaining REs to which CRSs are mapped can be removed. Particularly, since a CRS sequence is repeated every 10 subframes (one radio frame), CRSs can be removed if a Walsh cover code is applied to a PBCH transmitted per radio frame and then the PBCH is transmitted/received.

A detailed decoding process in an NB-IoT UE is as follows.
A phase reference is estimated using an NB-RS.
The phase reference is corrected for all received signals.
A Walsh cover code corresponding to each subframe is multiplied by symbols of REs.
Symbols of REs in subframes corresponding to the length of the Walsh cover code are added.
Receive power of each RE is measured and, when the receive power is lower than a predetermined threshold value, the RE is regarded as a legacy CRS RE (RE to which a legacy CRS is mapped).
Decoding of received signals excluding legacy CRS RE detected in the above step is attempted.

It is assumed that the UE knows Walsh cover code related information (e.g., Walsh cover code start point) necessary for multiplication of symbols of REs by the Walsh cover code through blind detection of a synchronization signal.

In the process of measuring receive power of each RE, the UE may compare a legacy CRS RE pattern already known to the UE with estimated legacy CRS RE patterns and consider that a most similar RE pattern has been used by the base station for CRS transmission. Specifically, the UE can add RE (reception) energies of REs corresponding to CRS pattern candidates and regard a CRS pattern candidate having RE energy lower than a predetermined threshold value to be an RE pattern used by the base station for legacy CRS transmission. Furthermore, the UE can collect estimated legacy CRS information over multiple subframes to detect a legacy CRS pattern.

Alternatively, to detect a legacy CRS pattern, the UE may attempt decoding as follows.
A phase reference is estimated using an NB-RS.
The phase reference is corrected for all received signals.
Symbols of REs of each subframe are added without being multiplied by a Walsh cover code.
Receive power of each RE is measured and, when the receive power exceeds a predetermined threshold value, the RE is regarded as a legacy CRS RE.

In determination of a legacy CRS RE depending on the predetermined threshold value, the UE can compare a legacy CRS RE pattern already known to the UE with estimated legacy CRS RE patterns and consider that a most similar RE pattern has been used by the base station for CRS transmission. Specifically, the UE can add reception energies of REs corresponding to a legacy CRS RE pattern instead of detecting legacy CRS REs one by one and consider that the base station has transmitted a legacy CRS using the corresponding CRS RE pattern when the added value exceeds the predetermined threshold value.

Distinguished from FIG. 5, a Walsh cover code may be applied to both PBCH data and an NB-RS. FIG. 6 illustrates an example in which a Walsh cover code is applied to PBCH data and an NB-RS.

When ports of the NB-RS and CRS are mapped, mapping depends on a radio frame and thus it cannot be considered that a Walsh cover code has been applied to PBCH data from the viewpoint of NB-RS ports. If cross-subframe channel estimation is used in order to additionally obtain interference suppression of the NB-RS, subframes using the same Walsh cover code need to be gathered to perform channel estimation for phase reference through the NB-RS.

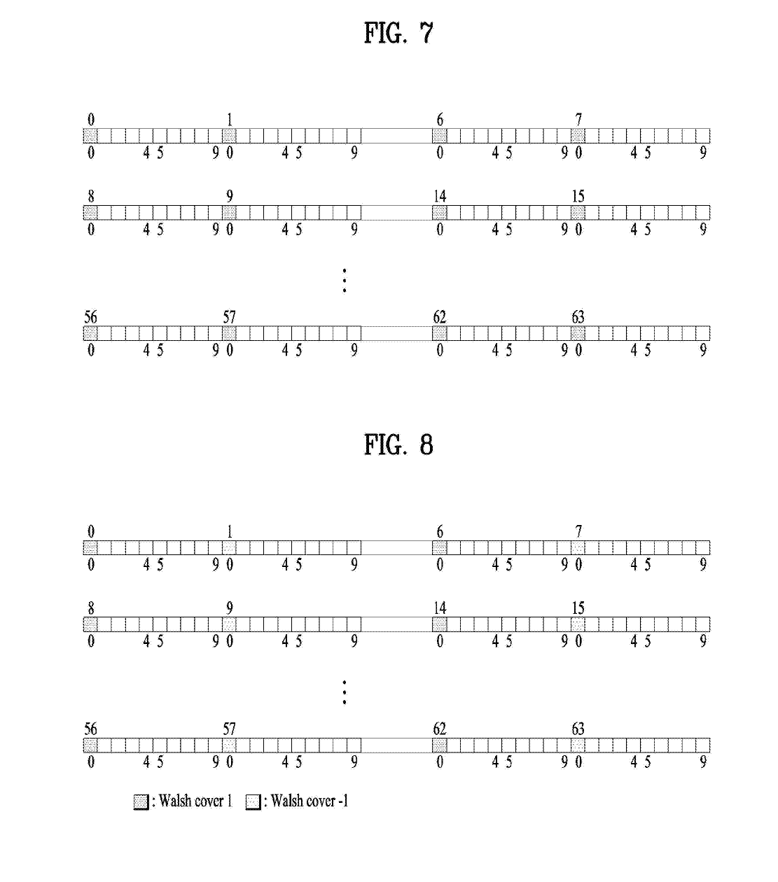

FIG. 7 illustrates a transmission scheme currently considered for an NB-IoT PBCH.

FIG. 7 shows an example wherein a PBCH is repeatedly transmitted 64 times (N=64) in one subframe in one radio frame. Here, a Walsh cover code to be applied to the PBCH can be predefined in both a base station and a UE or signaled to the UE by the base station. The base station alternately applies the Walsh cover code to subframes in which the PBCH is transmitted and transmits the PBCH and the UE decodes repeated PBCH subframes using the Walsh cover code.

FIG. 8 illustrates a method of transmitting a PBCH to which a specific Walsh cover code has been applied according to an embodiment of the present invention. In FIG. 8, a Walsh cover code {1, −1} is used.

The base station can repeatedly transmit the same PBCH data to the UE while multiplying odd-numbered radio frames by 1 and multiplying even-numbered radio frame by −1. In this case, the UE can receive an even number (L=2) of PBCHs corresponding to the length of the Walsh cover code and then combine the PBCHs using the Walsh cover code and decode the PBCHs. In this case, the PBCHs can be combined after phase compensation using an NB-RS transmitted in subframes.

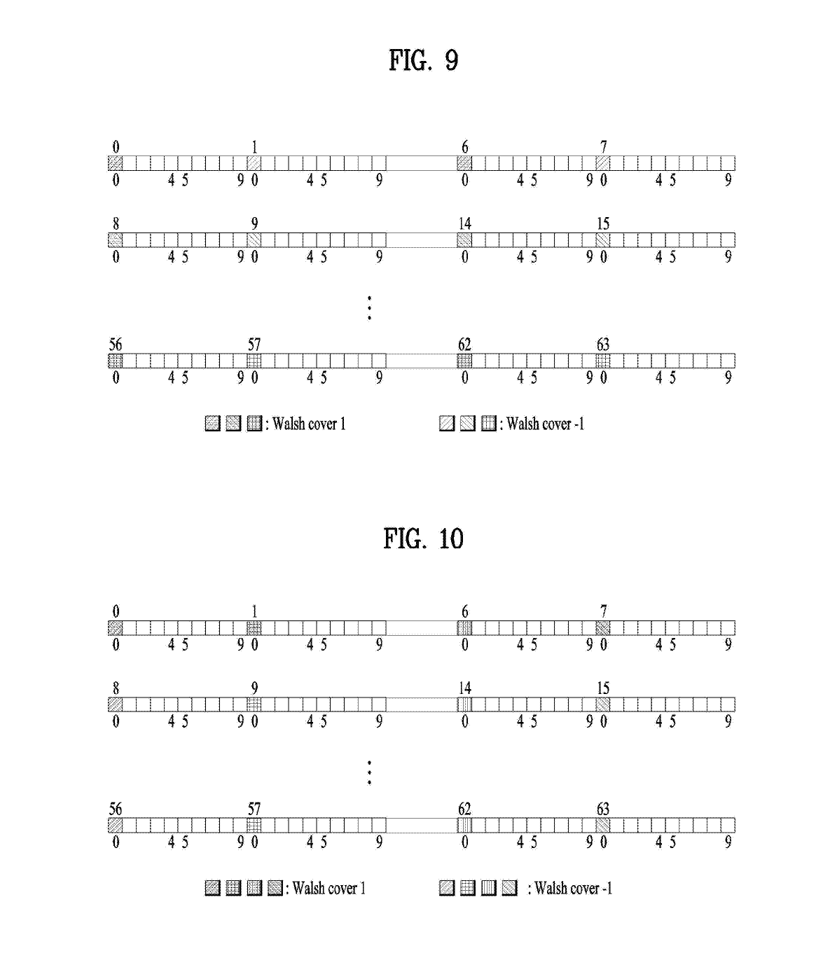

The method illustrated in FIG. 8 may be used for a case in which different scrambling sequences are applied to PBCHs and the PBCHs are transmitted. FIG. 9 illustrates a case in which different scrambling sequences are used for radio frames in such a manner that one scrambling sequence is used for 8 radio frames (80 ms), a Walsh cover code is applied to the same PBCH data in each PBCH block and the PBCH data is repeatedly transmitted.

In this case, it is desirable that the length of the Walsh cover code be selected as one of even numbers (2, 4 and 8 in the above example) from among divisors of a frame length (8 radio frames in FIG. 9) using the same scrambling sequence.

Even when the transport block size (TBS) of the PBCH is extended to transmit the PBCH over multiple radio frames, a method similar to the method of FIG. 9 can be used. If the PBCH is extended for a specific frame block (e.g., 80 ms) and transmitted, different data are transmitted in neighboring PBCH transmission instances (e.g., within 80 ms) and thus a Walsh cover code can be applied per PBCH block. For example, if PBCH TBS is extended to 8 transmission instances and a Walsh cover code {1, −1} is used, {1} can be applied to odd-numbered blocks (e.g., radio frames #0 to #7), {−1} can be applied to even-numbered blocks (e.g., radio frames #8 to #15) and the blocks can be transmitted.

Even in this case, the corresponding PBCH block (e.g., 80 ms) needs to be repeatedly transmitted an even-number of times. The UE can receive PBCHs corresponding to the length of the Walsh cover code (2 to 16 transmission instances in the example of FIG. 10) and then combine PBCH blocks to attempt decoding.

A PBCH transmission position may vary. For example, 2 subframes can be used for 20 ms and included in one radio frame. In this case, a CRS used for two PBCHs included in one radio frame cannot be removed even using a Walsh cover code.

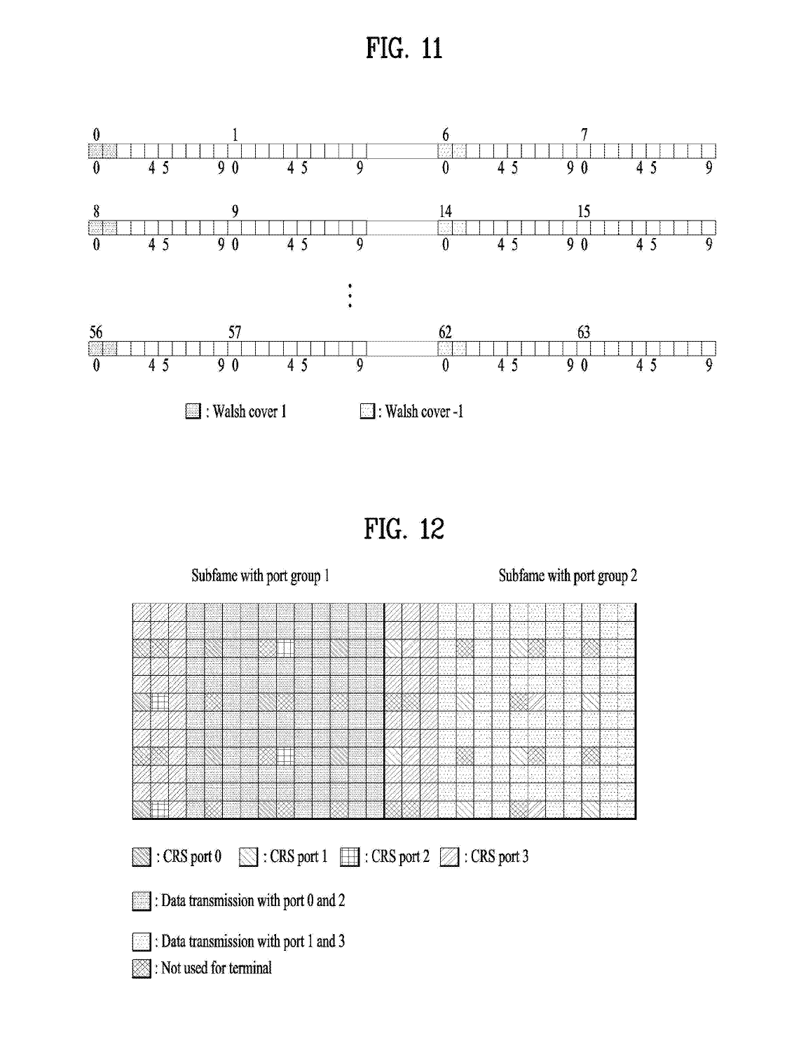

In this case, accordingly, a Walsh cover code is not applied to PBCHs within one radio frame and a Walsh cover code can be applied to PBCHs transmitted in the same radio frame. That is, in FIG. 11, the same Walsh cover code can be applied to PBCHs corresponding to 2 subframes transmitted in radio frame 0 and PBCHs corresponding to 2 subframes transmitted in radio frame 4 and the same Walsh cover code can be applied to PBCHs corresponding to 2 subframes transmitted in radio frame 2 and PBCHs corresponding to 2 subframes transmitted in radio frame 6.

Otherwise, the same Walsh cover code can be applied to PBCH subframes having the same subframe index (or number). That is, in each radio frame carrying a PBCH, {1, −1} can be used for a PBCH transmitted in subframe 0 and {−1, 1} can be used for a PBCH transmitted in subframe 1. In this case, the UE can combine subframes having the same number (index) in each radio frame in which the PBCH is transmitted and decode the PBCH.

To simply suppress interference between PBCH data without considering CRS removal, a method of applying the same Walsh cover code to neighboring PBCH subframes and transmitting/receiving the same may be considered.

The base station can inform the UE of a Walsh cover code start point through a method such as PSS/SSS (primary synchronization signal/secondary synchronization signal) blind detection by using different sequences for the PSS/SSS. If the Walsh cover code {1, −1} is used as above, although one blind detection candidate with respect to the PSS/SSS, that is, a Walsh cover code start point, increases, all available CRS RE candidates need not be punctured without additionally signaling a legacy LTE cell ID through the PSS/SSS and all REs that are not used for CRSs can be used for data transmission without signaling the number of CRS ports of legacy LTE.

In the case of an RS having a known pattern, such as the CRS, a receiver can evaluate REs removed as “0” (i.e., determined to be CRS REs). The UE can compare an RE pattern determined to be “0” with a known RS pattern, determine a most similar RS pattern and perform decoding on the assumption that the base station has transmitted RSs using the RS pattern. Here, an RE that is determined as an RS RE although not included in the RS pattern is a data symbol and can be reclassified as one of symbols of modulation (e.g., QPSK).

Although the examples are focused on the PBCH in the specification, the examples can be used for channels on which data other than the PBCH is transmitted. For example, a similar method can be used for synchronization channels. The base station can apply a 2-length Walsh cover code in the order of subframes in which an NB-PSS is transmitted and the UE can add signals of REs mapped to the NB-PSS included in an even number of subframes from a specific subframe to estimate the synchronization signal. In this case, the aforementioned synchronization signal blind detection operation for the Walsh cover code start point can be replaced by blind detection for the Walsh cover code instead of a different sequence. The order of multiplying the Walsh cover code can be determined by checking the positions of subframes in which NB-SSS1 and NB-SSS2 are transmitted.

In this case, it is necessary to recognize the sign of an estimated carrier frequency offset (CFO) due to the Walsh cover code during frequency offset estimation. To this end, CFO sign correction using the aforementioned Walsh cover code may be needed.

For example, decoding described below can be performed in order to separately detect a legacy CRS pattern at a synchronization stage.
Subframes are added without being multiplied by the Walsh cover code.
Received power of an RE is measured after discrete Fourier transform (DFT) and the RE is regarded as a legacy CRS RE when the received power exceeds a predetermined threshold value.

If the above method is used for a shared channel, it is possible to obtain inter-cell interference mitigation instead of CRS removal.

Port Rotation

For coverage improvement for an NB-IoT UE, technology such as port rotation is considered as one of candidates of technology for UE-transparently securing diversity for the NB-IoT UE. A basic transmission scheme with respect to port rotation is illustrated in FIG. 12.

FIG. 12 shows an example wherein ports 0 and 2 are defined as a port group, ports 1 and 3 are defined as another port group and the port groups are alternately used for data transmission per subframe. In FIG. 12, shaded squares indicate RS REs that are transmitted by a base station but are not used by a UE.

As illustrated in FIG. 12, since the base station needs to transmit a legacy CRS and has difficulty in directly correcting CRS port configuration for coexistence with legacy UEs, port rotation through port virtualization has been proposed. According to port rotation, when a base station performs data transmission for an NB-IoT UE using CRS ports 0 to 3 and/or NB-RS ports (e.g., ports 101 and 102), the base station transmits data by rotating actually used N antenna ports (P≦N, e.g., P=4 and N=2) from among available P antenna ports, and the UE receives data using a port configuration varying according to a pattern previously designated or known to both the base station and the UE through signaling or the like. Here, the UE may assume that N ports have been actually used for data transmission although P ports have been configured for the UE, or a configuration (e.g., RS pattern) of the N ports may vary according to rotation although the UE recognizes that the N ports have been configured therefor. Particularly, RS ports that are not used in a corresponding rotation unit may be assumed to be the N ports or the configuration of the N ports may vary according to rotation the UE may recognize the N ports as ports configured therefor. Particularly, with respect to an RS that is not used in the corresponding rotation unit, the UE may not use corresponding REs (rate matching) or may decode the REs. When the UE decodes the corresponding REs, an RS pattern transmitted from the base station to the UE needs to be rotated with time if the base station uses the REs to actually transmit data.

A port group for data transmission may be defined as follows.
1 port transmission

Alt 1. Only CRS ports can be used.

Accordingly, ports 0, 1, 2 and 3 are rotated.

Here, since ports 2 and 3 have lower CRS density than ports 0 and 1, an additional RS pattern for compensating for the CRS density may be additionally used.

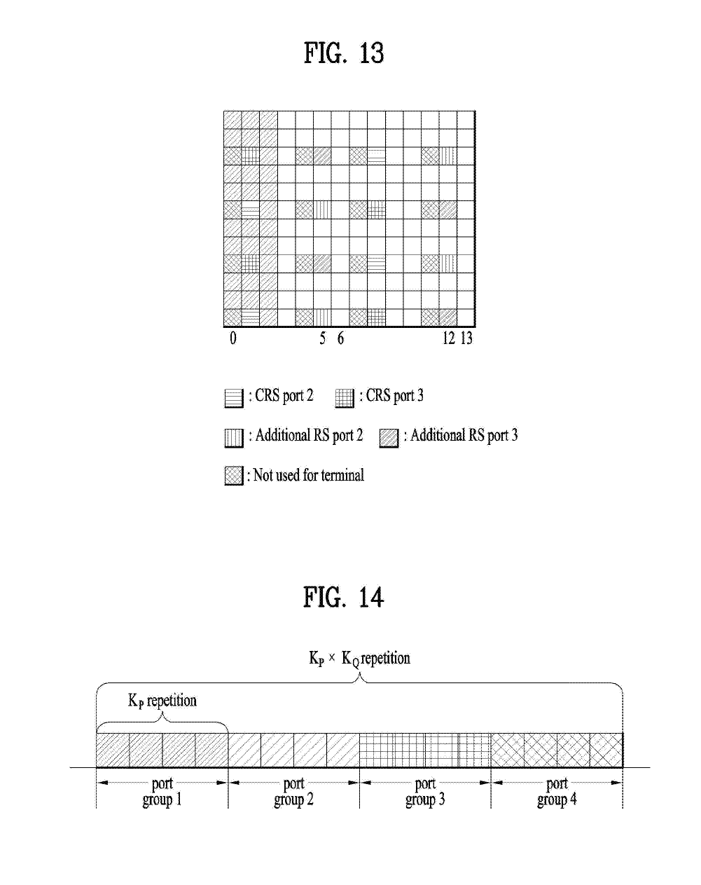

If channel estimation is performed using CRS port 2 and additional RS pattern 2 together and using CRS port 3 and additional RS port 3 together, as shown in FIG. 13, the same RS density as that of CRS ports 0 and 1 can be secured, thereby offsetting a performance difference between ports.

Alt 2. Rotation between a CRS port group and an NB-RS group can be performed.

The NB-RS is an RS defined for NB-IoT and is added to legacy LTE RSs such as the CRS. The NB-RS is defined in order to assist insufficient channel estimation capability due to narrowband characteristics of NB-IoT. Accordingly, when the NB-RS is defined/used, port rotation can be performed using both a CRS port group and an NB-RS port group.

A. A CRS port group can be rotate through ports 0, 1, 2 and 3.

B. A base station can define one or more NB-RS ports (e.g., 101 and 102) and perform rotation through the corresponding ports.

That is, rotation is performed in such a manner of port 0→port 101→port 2→port 102→port 1→port 101→port 3→port 102.

Alt 3. Only NB-RSs can be used.

A base station can define one or more NB-RS ports (e.g., 101 and 102) and perform rotation through the corresponding ports.
2 port transmission

In the following, (x, y) means transmission of a signal using ports x and y in a corresponding rotation unit.

Alt 1. Only CRS ports can be used.

i. Rotation within every possible port combination.

Data can be transmitted using one of port combinations (0, 1), (2, 3), (0, 2), (0, 3), (1, 2) and (1, 3).

ii. Rotation is performed between (0, 1) and (2, 3) in consideration of RS density.

In this case, RS density between ports can be maintained to be equal in subframes.

iii. Rotation is performed between (0, 2) and (1, 3) in consideration of 4Tx precoding for diversity.

In this case, RS density can be maintained in subframes. In addition, SFBC (Space-Frequency Block Coding) can be performed using ports 0 to 2 and ports 1 to 3 similarly to operation of SFBC-FSTD (Frequency Switched Transmit Diversity).

As described above, an additional RS pattern can be additionally used for ports 2 and 3.

Alt 2. Rotation between a CRS port group and an NB-RS port group can be performed.

Port groups can be defined as in the 1-port transmission described above and data can be transmitted within the port groups using rotation. For example, rotation such as ports (0, 2)→ports (101, 102)→ports (1, 3)→ports (101, 102) can be used.

Alt 3. Only NB-RSs can be used.

A. 4 or more NB-RS ports (e.g., 101, 102, 103 and 103) can be defined and used for rotation.

i. Rotation within every possible port combination

Port groups are selected from (0, 1), (2, 3), (0, 2), (0, 3), (1, 2) and (1, 3) and SFBC is applied thereto.

ii. Rotation is performed within 2 defined groups.

Port groups can be predefined and rotation can be performed between the port groups. For example, ports groups (101, 102) and (103, 104) can be defined and then rotation can be performed in a manner of (101, 102)→(103, 104).

Port Rotation Unit

Port rotation can be performed at predetermined intervals. For example, rotation can be performed through port groups (0, 1)→(2, 3)→(0 1) per subframe or performed in a different time unit. That is, a time unit for portion rotation can be as follows.

Alt 1. Every Subframe

Alt 2. Minimum Unit of Repetition

For coverage improvement, a base station can repeatedly transmit data over a plurality of subframes. In this case, repetition can be performed in a predetermined repetition unit. For example, K_{P} repetitions can be defined as a repetition unit and the repetition unit can be repeated K_{Q} times to obtain K_{P}*K_{Q} repetitions. In this case, rotation can be performed once for K_{P} repetitions corresponding to a minimum unit of repetition when the repetition unit is started. FIG. 14 illustrates an example of rotation in a repetition unit.

Particularly, when TTI extension is achieved and thus one-time data transmission is performed using K subframes, port rotation can be carried out once for K*K_{P} subframes.

Alt 3. Multi-Subframe Channel Estimation Unit

An NB-IoT UE can perform channel estimation using multiple subframes in order to supplement insufficient RSs of a narrowband that can be used by the UE for channel estimation. If the unit of multi-subframe channel estimation is K subframes, port rotation can be performed once for K subframes.

Here, since multi-subframe channel estimation needs to be performed only in subframes transmitted using the same port group, the UE can perform channel estimation using K subframe groups using the same port group. In this case, the subframe groups may not have a common subframe (i.e., disjoint).

Alt 4. Frequency Hopping Unit

When the NB-IoT UE uses frequency hopping, port hopping can be performed in the frequency hopping unit (e.g., K subframes).

To additionally obtain diversity according to port rotation, it is desirable that port rotation occur in RBs for which frequency hopping is performed. Accordingly, a rotation period such as 1/n (n and K/n being natural numbers) subframes of the frequency hopping unit can be used.

Alt 5. Resource Unit for Port Rotation

A separate unit for port rotation can be defined. When port rotation is performed in units of K subframes, the base station can define a “resource unit” of K subframes and signal the K subframes to the UE and the UE can receive data on the assumption that a port rotation configuration changes every K subframes.

Port Rotation Related Signaling
Content

A base station can transmit port rotation configuration information including the following information to a UE.

i. Port Group

Information about a port group can be transmitted to the UE in the form of a port configuration. This may include information such as an RS pattern group and an RS sequence.

ii. Rotation Pattern

For example, a rotation pattern may be (0, 1)→(2, 3)→(0, 1).

iii. Rotation Period
Delivery media

The base station can transmit port rotation configuration information to the UE through the following methods.

i. PBCH—MIB

ii. PDSCH—SIB

iii. PDSCH—RRC

iv. (e)PDCCH

Even when data is transmitted over an (e)PDCCH, the port rotation configuration information can be divided into specific sets and set indices can be transmitted to the UE. For example, when the port rotation configuration information is transmitted to the UE as shown in the following table, one of port rotation configuration sets 0 and 1 can be signaled to the UE through a 1-bit indicator. The following table can be signaled to the UE through RRC.

TABLE 6

| | Port rotation | Rotation cycle/period |
|---|---|---|
| Set 0 | (0, 1) [symbol] (2, 3) | 1 subframe |
| Set 1 | (0, 2) [symbol] (1, 3) | 1 subframe |

The port rotation configuration information through signaling may be defined depending on coverage level and transmitted. In addition, the port rotation configuration information may include information indicating activation or deactivation of port rotation. Furthermore, the port rotation information may be cell-specific or UE-specific.

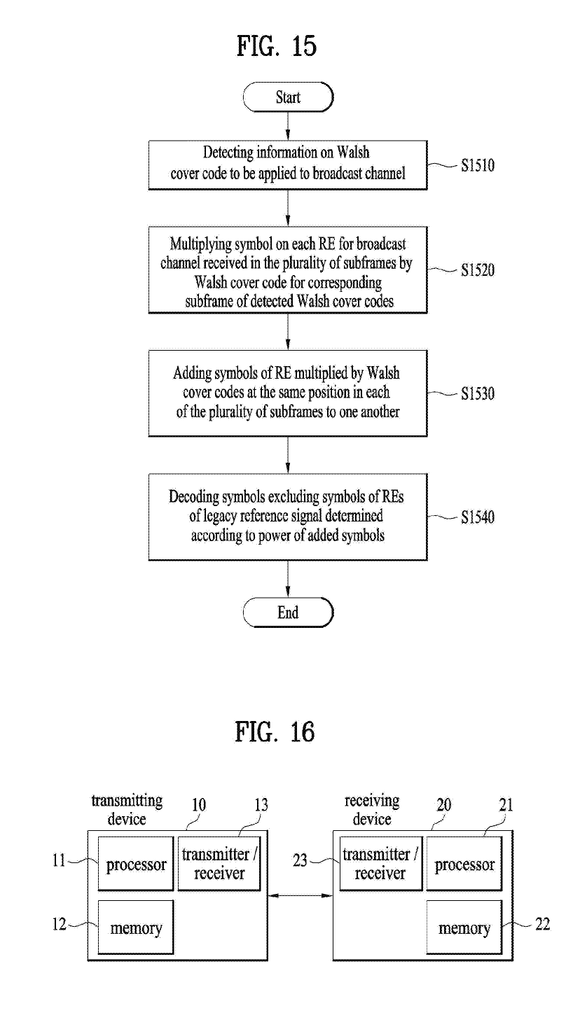

FIG. 15 illustrates operation according to an embodiment of the present invention.

FIG. 15 shows a method for receiving a broadcast channel repeatedly transmitted in a plurality of subframes in a wireless communication system. The method can be performed by a UE.

The UE may detect information on a Walsh cover code to be applied to the broadcast channel (S1510). Then, the UE may multiply symbols of resource elements (REs) for the broadcast channel, received in each of the plurality of subframes, by an element of the detected Walsh cover code for a respective subframe (S1520). The UE may add symbols of RE multiplied by a corresponding element of the detected Walsh cover code at the same position in each of the plurality of subframes in which the broadcast channel is received (S1530). Addition of REs at the same position in the subframes results in boost effects because the broadcast channel is transmitted after the Walsh cover code has been applied if the Walsh cover code has different signs in at least two subframes and removes data other than the broadcast channel because the data is transmitted without application of the Walsh cover code thereto.

The UE may decode symbols excluding symbols of REs of a legacy reference signal determined according to power of the added symbols (S1540).

The length of the Walsh cover code may be an even number equal to or greater than 2. The Walsh cover code may include the same number of +1 and −1.

In addition, the information on the Walsh cover code can be detected through blind detection of a synchronization signal.

Furthermore, the broadcast channel can be received through a plurality of radio frames within a predetermined period. Here, the same Walsh cover code can be applied to subframes within the plurality of radio frames.

The broadcast channel can be received in each of a plurality of radio frames within a predetermined period. Here, the same Walsh cover code can be applied to subframes having the same index in the plurality of radio frames.

The number of subframes can be equal to the length of the Walsh cover code.

While an embodiment of the present invention has been described with reference to FIG. 15, the embodiment may alternatively or additionally include at least part of the embodiments described above.

FIG. 7 is a block diagram of a transmitting device 10 and a receiving device 20 configured to implement exemplary embodiments of the present invention. Referring to FIG. 7, the transmitting device 10 and the receiving device 20 respectively include transmitter/receiver 13 and 23 for transmitting and receiving radio signals carrying information, data, signals, and/or messages, memories 12 and 22 for storing information related to communication in a wireless communication system, and processors 11 and 21 connected operationally to the transmitter/receiver 13 and 23 and the memories 12 and 22 and configured to control the memories 12 and 22 and/or the transmitter/receiver 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the transmitter/receiver 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transmitter/receiver 13 may include an oscillator. The transmitter/receiver 13 may include Nt (where Nt is a positive integer) transmit antennas.

A signal processing process of the receiving device 20 is the reverse of the signal processing process of the transmitting device 10. Under the control of the processor 21, the transmitter/receiver 23 of the receiving device 10 receives RF signals transmitted by the transmitting device 10. The transmitter/receiver 23 may include Nr receive antennas and frequency down-converts each signal received through receive antennas into a baseband signal. The transmitter/receiver 23 may include an oscillator for frequency down-conversion. The processor 21 decodes and demodulates the radio signals received through the receive antennas and restores data that the transmitting device 10 wishes to transmit.

The transmitter/receiver 13 and 23 include one or more antennas. An antenna performs a function of transmitting signals processed by the transmitter/receiver 13 and 23 to the exterior or receiving radio signals from the exterior to transfer the radio signals to the transmitter/receiver 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An transmitter/receiver supporting a MIMO function of transmitting and receiving data using a plurality of antennas may be connected to two or more antennas.

The transmitting device and/or the receiving device may be configured as a combination of one or more embodiments of the present invention.

The embodiments of the present application has been illustrated based on a wireless communication system, specifically 3GPP LTE (-A), however, the embodiments of the present application can be applied to any wireless communication system in which interferences exist.

It will be apparent to those skilled in the art that various modifications and variations can be made in the present invention without departing from the scope of the inventions. Thus, it is intended that the present invention covers the modifications and variations of this invention provided they come within the scope of the appended claims and their equivalents.

What is claimed is:

1. A method for receiving a broadcast channel repeatedly transmitted in a plurality of subframes in a wireless communication system, comprising:
detecting, by a terminal, information on Walsh cover code to be applied to the broadcast channel;
multiplying, by the terminal, symbols of resource elements (REs) for the broadcast channel, received in each of the plurality of subframes, by an element of the detected Walsh cover code for a respective subframe;
adding, by the terminal, symbols of RE multiplied by a corresponding element of the detected Walsh cover code at the same position in each of the plurality of subframes to each other; and
decoding, by the terminal, symbols except for symbols of REs of a legacy reference signal determined based on power of the added symbols.

2. The method according to claim 1, wherein the length of the Walsh cover code is an even number equal to or greater than 2.

3. The method according to claim 1, wherein the Walsh cover code includes the same number of +1s and −1s as elements.

4. The method according to claim 1, wherein the information on the Walsh cover code is detected through blind detection of a synchronization signal.

5. The method according to claim 1, wherein the broadcast channel is received through a plurality of radio frames within a predetermined period.

6. The method according to claim 5, wherein the same Walsh cover code is applied to subframes within the plurality of radio frames.

7. The method according to claim 1, wherein the broadcast channel is received in each of a plurality of radio frames within a predetermined period.

8. The method according to claim 7, wherein the same Walsh cover code is applied to subframes having the same index in the plurality of radio frames.

9. The method according to claim 1, wherein the number of subframes is equal to the length of the Walsh cover code.

10. A terminal configured to receive a broadcast channel repeatedly transmitted in a plurality of subframes in a wireless communication system, comprising:
a transmitter and a receiver;
a processor configured to control the transmitter and the receiver,
wherein the processor is configured to detect information on Walsh cover code to be applied to the broadcast channel, to multiply symbols of resource elements (REs) for the broadcast channel, received in each of the plurality of subframes, by an element of the detected Walsh cover code for a respective subframe, to add symbols of RE multiplied by a corresponding element of the detected Walsh cover code at the same position in each of the plurality of subframes to each other, and to decode symbols except for symbols of REs of a legacy reference signal determined based on power of the added symbols.

11. The terminal according to claim 10, wherein the length of the Walsh cover code is an even number equal to or greater than 2.

12. The terminal according to claim 10, wherein the Walsh cover code includes the same number of +1s and −1s as elements.

13. The terminal according to claim 10, wherein the information on the Walsh cover code is detected through blind detection of a synchronization signal.

14. The terminal according to claim 10, wherein the broadcast channel is received through a plurality of radio frames within a predetermined period.

15. The terminal according to claim 14, wherein the same Walsh cover code is applied to subframes within the plurality of radio frames.

16. The terminal according to claim 10, wherein the broadcast channel is received in each of a plurality of radio frames within a predetermined period.

17. The terminal according to claim 16, wherein the same Walsh cover code is applied to subframes having the same index in the plurality of radio frames.

18. The terminal according to claim 10, wherein the number of subframes is equal to the length of the Walsh cover code.
